(19) United States
(12) Patent Application Publication
(10) Pub. No.: US 2004/0100221 A1
(43) Pub. Date: May 27, 2004

(54) Field weakening with full range torque control for synchronous machines

(76) Inventor: Zhenxing Fu, Ann Arbor, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/304,106

(22) Filed: Nov. 25, 2002

(51) Int. Cl. H02P 1/46

(52) U.S. Cl. 318/700

(57) ABSTRACT

A permanent magnet synchronous machine having a base speed is controlled in response to a d-axis current command I_{dse}*. A torque command Tₑ* is determined and an angular velocity ωᵣ of the machine is sensed. A maximum torque per ampere value is calculated for producing the commanded torque Tₑ* at speeds below the base speed. The angular velocity ωᵣ is compared with the base speed. If the angular velocity ωᵣ is less than the base speed, then the maximum torque per ampere value is employed as the d-axis current command I_{dse}*. If the angular velocity ωᵣ is greater than the base speed, then the maximum torque per ampere value adjusted by a field-weakening factor proportional to the angular velocity ωᵣ is employed as the d-axis current command I_{dse}*.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates in general to controlling permanent magnet synchronous dynamoelectric machines, and, more specifically, to adjustments within field-weakening operation so that the machine is well controlled over a wide range of speeds even at low or zero values of commanded torque.

AC electric machines, such as induction, synchronous, reluctance machines, are very useful in high performance electric drive applications. For applications where system efficiency, system size, torque density, and dynamic response time are of concern, permanent magnet (PM) synchronous machines are often preferred. PM synchronous machines are especially well suited for use as motors with low power ratings or with large mechanical air gaps. They typically require a power supply with sinusoidal voltage waveforms for excitation. The voltage commands for controlling such machines are typically generated using vector control techniques, also known as field oriented control (FOC), to achieve fast dynamic response, high efficiency, optimal peak transient power or torque capability, and a wide range of operating speeds.

Worldwide demand for fuel-efficient, low-emission vehicles have motivated the automotive industry to develop alternative powertrain architectures, such as 1) integrated starter alternator (ISA) systems for stop/start vehicles, 2) hybrid combinations of an electric traction motor and a downsized internal combustion (IC) engine for hybrid electric vehicles (HEV), and 3) purely electric vehicles (EV). Because PM synchronous machines have the advantages of high efficiency, small size and volume, high torque and power densities, and fast dynamic response, they have become increasingly popular in these automotive applications as ISA motors for stop/start vehicles, and traction motors for HEV's and EV's. In addition, they are also popularly used in electric power assisted steering (EPAS) applications as steering wheel torque assist actuators.

Because of packaging and weight constraints in the automotive underhood environment, the PM synchronous machines used in HEV, ISA, or EV applications typically use high-energy rare-earth magnet materials and are designed into pancake shapes with high numbers of magnetic poles. Considering the maximum engine operating speed of 6000 RPM, the maximum electrical speed of the electric machine reaches 36,000 to 108,000 RPM for 12 to 36 magnetic pole configurations. Such a high operating electrical speed in conjunction with small size and weight constraints requires the machine drive system to have a maximum speed to base speed ratio of 5 or 6, or even higher. Consequently, it is necessary to utilize the field weakening regime of motor control. To achieve such a wide range of operating speeds and other performance requirements (e.g., fast dynamic response, high efficiency, high torque and speed control precision, and optimal peak transient power/torque capability), vector or field oriented control techniques become a necessity. Field oriented control is also necessary to meet drive system requirements of being able to operate at every torque load point as defined by the maximum torque-speed envelope to provide torque boost, driveline disturbance damping, regenerative braking, synchronization for gear shifts via speed controls, and starting of the IC Engine.

The rotation of the permanent magnets in the rotor creates a back-EMF that is proportional to the airgap magnetic flux (created by the magnets) and the rotor's angular velocity ωᵣ. Under normal conditions, the magnitude of the airgap flux is substantially constant (although always changing in direction). At higher speeds, however, the induced back-EMF may approach the magnitude of the supply voltage such that there is no additional voltage to generate motor currents and, thus, the developed motor torque is zero. This is especially a problem in automotive vehicles which rely on battery voltages that are relatively low (e.g., 300 volts). The highest speed at which the motor can deliver peak transient torque without using demagnetizing stator current is referred to as the base speed. In order to obtain motor operation above base speed, field weakening is necessary. Supplying a component of stator current opposing the flux produced by the magnets in the field-weakening mode of operation results in a lower resultant airgap flux and a reduced back-EMF, thereby enabling the motor to operate at higher angular speeds.

A typical strategy for generating a current command when using a vector control method is known as the “maximum torque per ampere” control strategy. This strategy attempts to find the optimal current angle for developing the maximum developed torque. Calculations are typically based on setting the partial derivative of developed torque Tₑ with respect to current angle γ equal to zero (i.e., ∂Tₑ/∂γ=0). Based on the commanded torque and the optimal current angle, a flux current command I_{dse}* is calculated. Alternatively, an I_{dse}* scheduler can be constructed using lookup tables to make fixed-point implementation easier in the motor controller.

Utilizing the “maximum torque per ampere” strategy for field weakening operation is possible but is significantly more complex so that fixed-point, real time implementation is not practical. Furthermore, such an implementation depends heavily on machine parameters such as temperature, magnetic saturation, which cannot be accurately measured over a wide range of operating conditions.

Field weakening has been previously attempted through the rotation of the stator current command vector Iₛ* toward the d-axis based on the voltage constraint at higher speeds. However, this action fails to control the motor at high speeds and low torque because the command of low or zero torque results in a low or zero value of Iₛ* and, therefore, there is little or nothing to rotate in order to create the desired field weakening. Consequently, high speed performance of ISA, HEV, and EV systems in particular all suffer from inadequate torque boost, inadequate driveline disturbance damping, poor regenerative braking, poor speed control during gear shifts, and poor fuel economy.

An alternative prior art approach has been to avoid high motor speeds (i.e., reducing the maximum operating speed of the machine) by connecting a transmission at the mechanical output of the drive. However, these systems lead to complex and bulky transmission gearboxes and/or increased cost, especially when a variable transmission gearbox is used.

### SUMMARY OF THE INVENTION

The present invention has the advantages of maintaining stability of synchronous machines at high speeds at all torque loads by introducing field weakening in a manner not only dependent upon the commanded torque but also the operating speed.

In one aspect of the invention, a method is provided for determining a d-axis current command I_{dse}* for controlling a permanent magnet synchronous machine having a base speed. A torque command Tₑ* is determined and an angular velocity ωᵣ of the machine is sensed. A maximum torque per ampere value is calculated for producing the commanded torque Tₑ* at speeds below the base speed. The angular velocity ωᵣ is compared with the base speed. If the angular velocity ωᵣ is less than the base speed, then the maximum torque per ampere value is employed as the d-axis current command I_{dse}*. If the angular velocity ωᵣ is greater than the base speed, then the maximum torque per ampere value adjusted by a field-weakening factor proportional to the angular velocity ωᵣ is employed as the d-axis current command I_{dse}*.

### BRIEF DESCRIPTION OF THE DRAWINGS

FIG. 1 is a block diagram of a PM synchronous motor drive system of the present invention.

FIG. 2 is a schematic, block diagram of a vector-controlled, field oriented motor controller in a preferred embodiment of the present invention.

FIG. 3 is a schematic, block diagram of a preferred embodiment of the flux current strategizer of the present invention.

FIG. 4 is a plot of actual phase currents achieved during high speed operation of the present invention.

### DETAILED DESCRIPTION OF PREFERRED EMBODIMENTS

The present invention is comprised of a quasi-maximum torque per ampere strategy which is adopted for speeds higher than the base speed in order to ensure proper machine operation at zero or low torque loads. A relatively simple algorithm is provided that is easily implemented using a fixed-point processor and that meets the performance requirements for traction motors in automotive ISA, HEV, and EV applications.

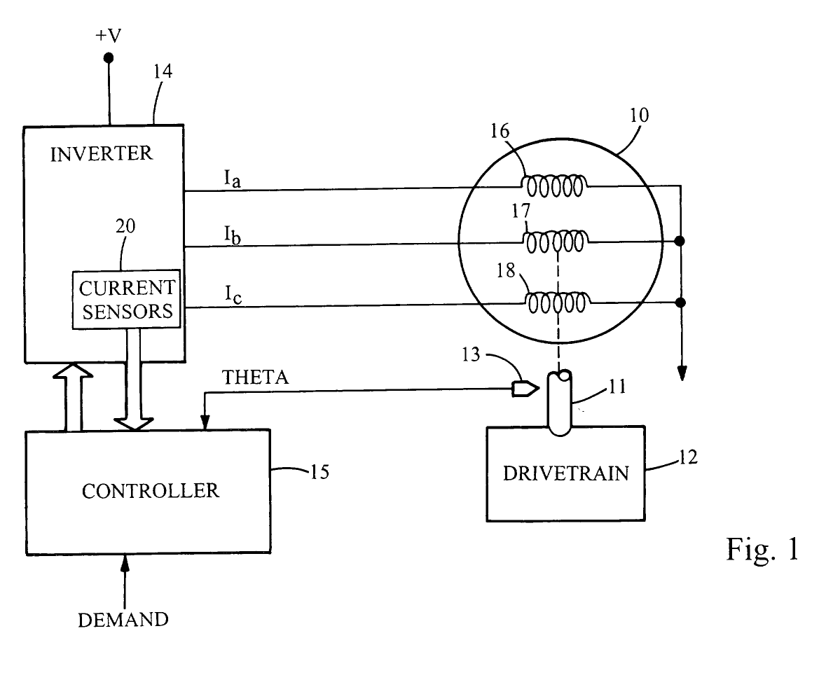

As shown in FIG. 1, a synchronous motor drive system may typically include a PM synchronous motor 10 with an output shaft 11 connected to a vehicle drivetrain 12, a position sensor 13 (or alternatively a position estimation mechanism in the controller in order to provide a sensorless embodiment), a power electronics inverter 14, and a controller apparatus 15. Motor 10 is shown as a 3-phase motor with phase windings 16-18, each connected between inverter 14 and ground. Inverter 14 may, for example, comprise current sensors 20, as well as a plurality of power electronics switches, a DC bus filter capacitor, a gate drive circuitry to control the power electronics switches, a cold plate to cool the power electronics switches, and a housing (not shown). Inverter 14 supplies phase currents Iₐ, I_{b}, and I_{c} to phase windings 16, 17, and 18, respectively.

Controller 15 may be of a mostly conventional type with improvements as described herein. In construction, it may comprise a number of analog electronic components on a printed circuit board, a microprocessor or digital signal processor chip, and other digital electronic components. Controller 15 receives a position signal Theta from position sensor 13, measured current signals Iₐ and I_{b} in the stationary frame from current sensors 20, and a demand signal which may for example be a speed command as requested from a vehicle operator (e.g., via an accelerator pedal) or a supervisory powertrain controller.

Specific conventions are followed in the nomenclature of the variables throughout this specification. For example, a variable followed by “*” denotes a command value (i.e., a value for the variable representing an input by the vehicle supervisory controller or another internal process). Variables in the rotating vector reference frame include a subscript “d” which denotes a vector component in the direct axis (i.e., the direction of the current flow which is typically is responsible for production of the magnetic field or magnetic flux) or a subscript “q” which denotes a vector value in the quadrature (i.e., perpendicular) axis. The q-axis vector component is typically responsible for the production of torque.

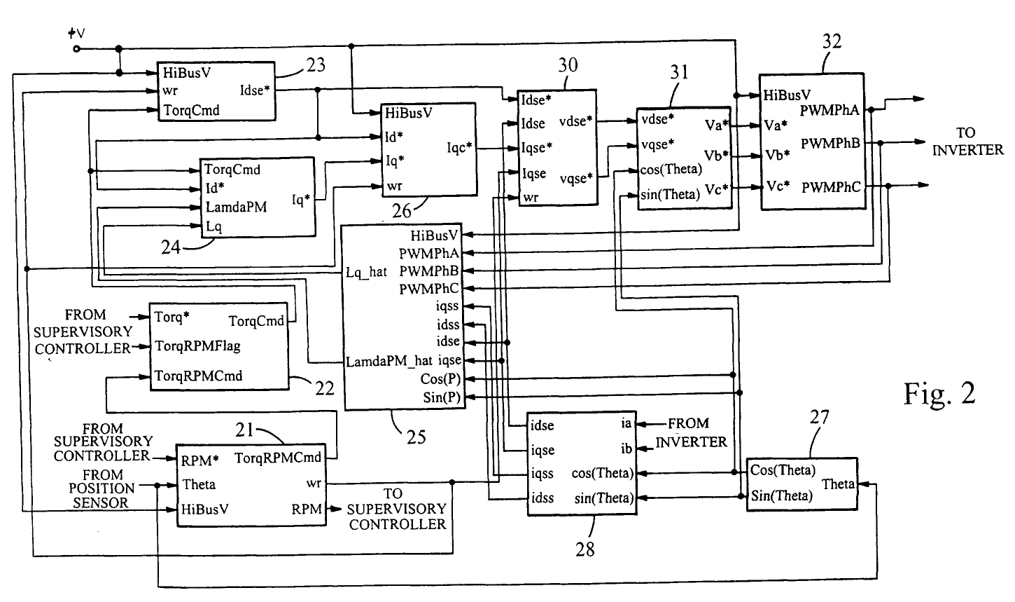

FIG. 2 shows controller 15 in greater detail. A speed regulator 21 receives motor position signal Theta from the position sensor or position estimator, a speed command RPM* from the supervisory controller, and the inverter voltage level HiBusV. It calculates and outputs the mechanical speed of the motor in revolution per minute RPM, electrical speed in radians per second, ωᵣ, and a torque command TorqRPMCmd required to achieve the speed command RPM*. Speed command RPM* may be given by conventional methods, such as the position of a vehicle operator's foot on an accelerator, or may be the result of a set speed on a cruise control system, or determined by the supervisory controller during gearshifts, for example. Motor position Theta is preferably measured by a motor position sensor located on the PM motor, and most preferably located on the rotor shaft of the PM motor. Speed regulator 21 preferably includes a proportional-integral-derivative (PID) controller, wherein the integrator is designed with anti-windup mechanisms to reduce the speed error, as is known in the art. Preferably, the anti-windup mechanisms prevent the integrator from winding up after any saturation of the PID controller.

A torque command to achieve commanded speed (TorqRPMCmd) and a normal torque command Torq* are provided as inputs to a mode selector 22. The supervisory controller (not shown) determines whether the drive system is to run in a speed control mode or a torque control mode and generates a corresponding mode flag TorqRPMFlag. The TorqRPMFlag flag may comprise a digital signal from the vehicle supervisory controller which selects the control mode as described. Speed control mode may preferably be used during gear shifts or engine cranking in case of HEV, whereas torque control mode is preferably used for normal driving and for charging the battery. Mode selector 22 selects either Torq* or TorqRPMCmd to output as a torque command TorqCmd which is coupled to a flux current strategizer 23 and a current decoupler 24.

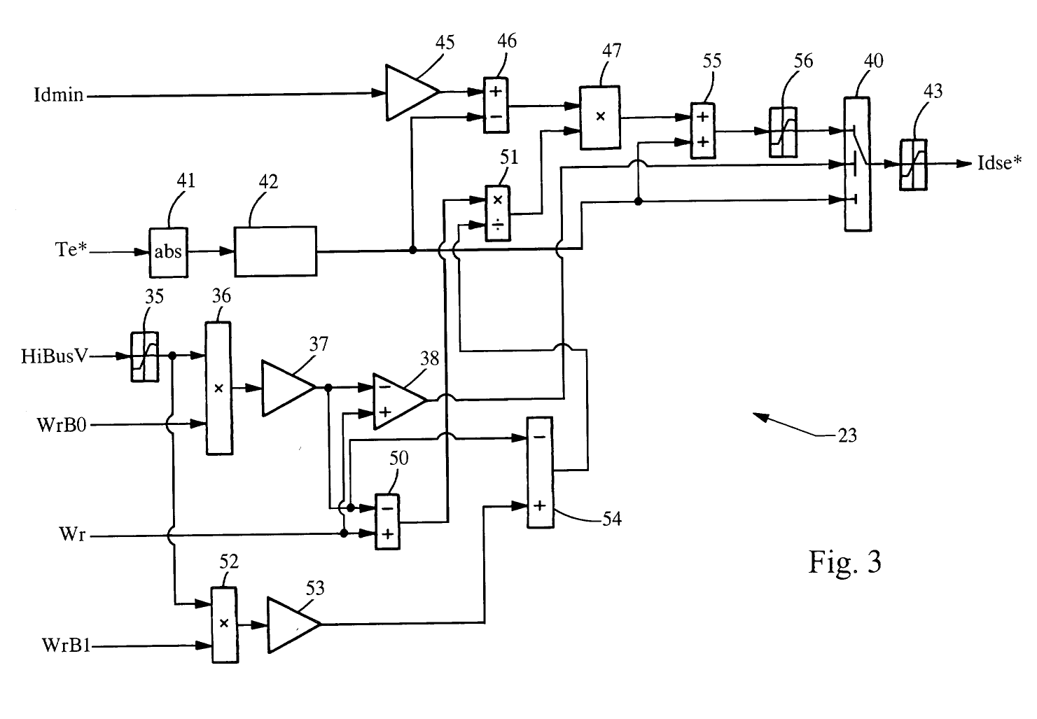

Flux current strategizer 23 determines a magnetizing (d-axis) current command I_{dse}*. Flux current strategizer 23 receives for its inputs the motor electrical speed ωᵣ, the torque command TorqCmd, and the inverter or battery voltage HiBusV. Strategizer 23 obtains significant improvements over the conventional “maximum torque per ampere” strategy at speeds at or above base speed by introducing a component of current command I_{dse}* which is proportional to angular speed ωᵣ, as described below with reference to FIG. 3.

Continuing with FIG. 2, current decoupler 24 calculates the required q-axis current, I_{q}*, for the motor to deliver the required torque command via the relationship between torque and quadrature current Iq as known in the art. Current decoupler 24 receives as inputs the d-axis current command I_{dse}*, the torque command TorqCmd, and the values of LamdaPM_hat and Lq_hat received from an open-loop parameter observer 25. This calculated q-axis current command, I_{q}*, is clamped by a limiter 26. The maximum current and voltage capabilities of the power electronics inverter and the motor determine the range in which I_{q}* will be clamped by limiter 26. Typically, upper and lower limits are established from modeling and measurements of the physical system. The clamped value I_{qc}* provides the q-axis current command I_{qse}*

Motor position Theta from sensor 13 is input to a position converter 27 which computes the sine and cosine values of the rotor electrical position, i.e., sin(Theta) and cos(Theta). The sine and cosine values are used in a vector rotation translator 28 to transform motor currents (e.g., measured current values for iₐ and i_{b} from inverter 14) from stationary reference coordinates to synchronous reference coordinates. Preferably, the vector rotation translator uses a Park transformation algorithm, as is known in the art. Thus, vector rotation translator 28 calculates d-axis and q-axis currents in synchronous reference coordinates, I_{dse} and I_{qse} from the motor phase currents in stationary reference coordinates (iₐ and i_{b}) by using appropriate sine and cosine values of the rotor electrical position Theta. As is known in the art, the vector representation in synchronous reference coordinates is a mathematical construct which decouples the effect of the motor phase currents according to their contributions to the magnetic flux and the torque. This representation of the current command vector yields quick and efficient control of the motor. After calculating target control values in vector form, they can be translated back to stationary coordinates for driving the PM synchronous motor.

A synchronous current regulator 30 calculates the voltages needed to regulate the d-axis and q-axis current commands, I_{dse}* and I_{qse}*, preferably using a proportional-integral regulator. Regulator 30 may be constructed as shown by copending U.S. application serial No. (V202-0108), entitled “Weighted Higher-Order Proportional-Integral Current Regulator for Synchronous Machines,” which is incorporated herein by reference in its entirety.

A second vector rotation translator 31 translates the resulting voltage commands, V_{dse}* and V_{qse}*, in synchronous reference coordinates back to stationary reference coordinates, Vₐ*, V_{b}*, and V_{c}*, for the three phases of the motor. Vector rotation translator 31 is preferably comprised of an inverse Park transformation. Voltage commands Vₐ*, V_{b}*, and V_{c}* represent the actual voltages to be applied to the motor via the power electronics inverter to regulate motor current, and thereby control the torque generated. Preferably, each regulated current waveform is sinusoidal, or AC. A PWM signal generator 32 calculates the necessary pulse-width modulated control signals. Preferably, PWM signal generator 32 uses a space vector modulation technique to synthesize sinusoidal voltage waveforms for minimizing voltage harmonics and improved use of effective inverter voltage, as is known in the art. The PWM signals for the individual motor phases (PWMPhA, PWMPhB, and PWMPhC) are sent to the gate drive circuitry to control the turn-on and turn-off of inverter switches.

Field weakening is obtained in a preferred embodiment by virtue of the operation of current strategizer 23 shown in greater detail in FIG. 3. A DC bus voltage HiBusV (measured at the inverter input) is clamped by a limiter 35 to a predetermined voltage range. The output of limiter 35 is multiplied by a nominal base speed ω_{rB0} (i.e., corresponding to a nominal supply voltage V_{dc0}) in a multiplier 36, the output of which is then multiplied in a gain block 37 by a gain equal to the inverse of nominal inverter-input voltage V_{dc0}. The output of gain block 37 represents an adjusted base speed ω′_{rB0} which compensates for any changes in the DC bus voltage. Actual measured speed ωᵣ is compared to adjusted base speed ω′_{rB0} in a comparator 38 which outputs a low logic level signal when actual speed ωᵣ is below adjusted base speed ω′_{rB0} and which outputs a high logic level when actual speed ωᵣ is above adjusted base speed ω′_{rB0}. The output of comparator 38 is connected to a control input of a selector switch 40 for selecting between two alternative flux current values for use as the flux current command I_{dse}*.

Torque command Tₑ* is input to an absolute value block 41 which provides the absolute value of torque command Tₑ* to a flux current scheduler 42. A nominal flux current value I_{dse0}* is determined by scheduler 42 according to a “maximum torque per ampere” strategy which attempts to maximize the value of the function:

$${T}_{e} = \frac{3 P}{4} [ {λ}_{PM} {i}_{qse} + ( {L}_{d} - {L}_{q} ) {i}_{dse} {i}_{qse} ]$$

where P is the number of poles, λ_{PM} is the flux linkage of the permanent magnets, L_{d} is the d-axis inductance, and L_{q} is the q-axis inductance. A maximized torque is obtained when the partial derivative of torque with respect to current angle is set to zero (i.e., ∂Tₑ/∂γ=0) under the condition that the magnitude of the stator current vector is a constant, such that:

$${sin}^{*} γ = \frac{- {λ}_{PM} - \sqrt{{λ}_{PM}^{2} + 8 {( {L}_{d} - {L}_{q} )}^{2} {i}_{ s}^{ 2}}}{4 ( {L}_{d} - {L}_{q} ) {i}_{s}}$$

where iₛ is the total stator current. Maximum torque per ampere control can be achieved by applying the following optimal current angle:

$${γ}^{*} = {sin}^{- 1} ( \frac{- {λ}_{P M} - \sqrt{{λ}_{P M}^{2} + 8 {( {L}_{d} - {L}_{q} )}^{2} {i}_{ s}^{ 2}}}{4 ( {L}_{d} - {L}_{q} ) {i}_{s}} )$$

Thus, from a given torque command, Te*, and the optimal current angle γ* given above, a below base speed flux current command, I_{dse0}* is calculated. Scheduler 42 can alternatively be comprised of lookup tables for ease of fix-point implementation. The below base speed command I_{dse0}* is coupled to one of the selectable inputs of selector switch 40 so that when comparator 38 indicates that actual speed is below adjusted base speed ω′_{rB0}, then I_{dse0}* is output by switch 40 through a limiter 43 for use as the flux current command I_{dse}*.

When comparator 38 indicates that actual speed is above adjusted base speed ω′_{rB0}, then selector switch 40 switches to its other input which receives a modified flux current command as follows:

$${I}_{dse}^{*} = {I}_{dse0}^{*} + ( {I}_{d min} \times {K}_{d} - {I}_{dse0}^{*} ) \times \frac{{ω}_{r} - {ω}_{r B0}^{′}}{{ω}_{r B1}^{′} - {ω}_{r B0}^{′}}$$

where the primed variables have been adjusted for the actual supply voltage. The constant I_{dmin} represents the negative stator current at which demagnetization of the permanent magnets may begin to occur. It is multiplied by calibration gain K_{d} in a gain block 45. Calibration gain K_{d} may preferably have a constant value less than or equal to one and is used to adjust the slope of the field weakening transfer function. The output of gain block 45 is coupled to a positive input of a summer 46. A subtracting input of summer 46 receives the I_{dse0}* value from scheduler 42. The difference value from summer 46 is coupled to one input of a multiplier 47.

Actual angular speed ωᵣ is coupled to a positive input of a summer 50. The subtracting input of summer 50 receives the adjusted base speed ω′_{rB0}. The difference between angular speed ωᵣ and adjusted base speed ω′_{rB0} is provided as the output from summer 50 to the numerator input of a divider 51.

A calibration speed ω_{rB1} is coupled to one input of a multiplier 52 which receives the actual supply voltage HiBusV from limiter 35. The product from multiplier 52 is multiplied by nominal inverter-input voltage V_{dc0} in a gain block 53 to generate the adjusted calibration speed ω′_{rB1} which is input to a positive input of a summer 54. The subtracting input of summer 54 receives adjusted base speed ω′_{rB0}. The difference is input to the dividing input of divider 51 such that the speed term of the modified flux current equation is produced. The speed term is coupled to another input of multiplier 47, the product of which is added to I_{dse0}* in a summer 55. The sum is passed through a limiter 56 (to avoid out of range flux current commands and to avoid demagnetizing the permanent magnets) and to the second selector input of switch 40 to yield the final modified flux current command value that is selected at speeds above adjusted base speed.

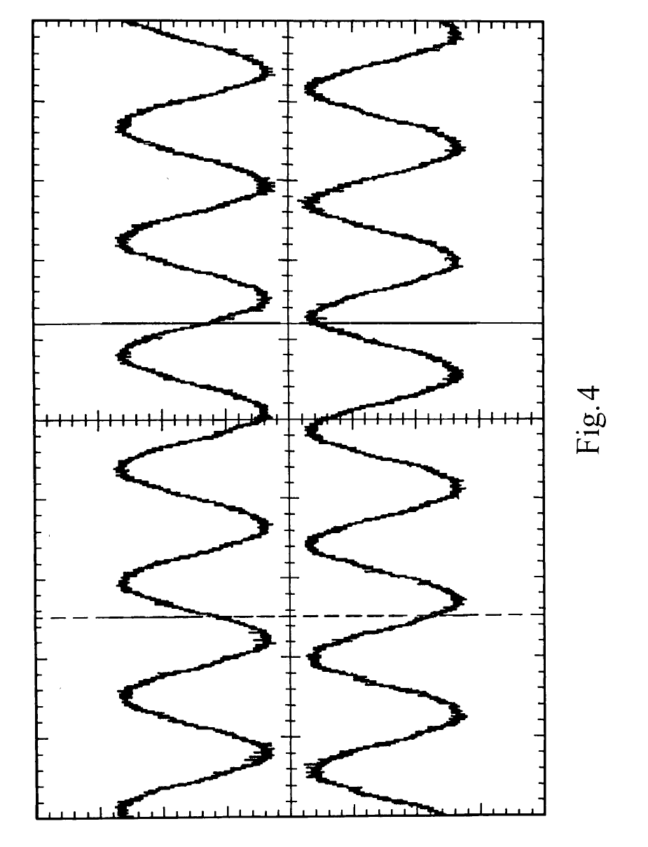

As is apparent from FIG. 3, the modified flux current command calculations can be easily implemented using fixed-point processors. FIG. 4 shows machine phase current waveforms obtained using the present invention at 3500 RPM and a torque of 0 Nm. Thus, the field weakening strategy of the present invention operates with excellent accuracy even at zero and light torque load conditions.

Although shown in connection with a PM synchronous motor, it will be apparent to those skilled in the art that the invention can be applied in to vector controls of AC dynamoelectric machines in general.

What is claimed is:

1. A method of determining a d-axis current command I_{dse}* for controlling a permanent magnet synchronous machine having a base speed, said method comprising the steps of:
determining a torque command Tₑ*;
sensing an angular velocity ωᵣ of said machine;
calculating a maximum torque per ampere value for producing said commanded torque Tₑ* at speeds below said base speed;
comparing said angular velocity ωᵣ with said base speed;
if said angular velocity ωᵣ is less than said base speed, then employing said maximum torque per ampere value as said d-axis current command I_{dse}*; and
if said angular velocity ωᵣ is greater than said base speed, then employing said maximum torque per ampere value adjusted by a field-weakening factor proportional to said angular velocity ωᵣ as said d-axis current command I_{dse}*.

2. The method of claim 1 wherein said field-weakening factor is substantially defined by
$$( {I}_{d min} \times {K}_{d} - {I}_{dse0}^{*} ) \times \frac{{ω}_{r} - {ω}_{r B0}^{′}}{{ω}_{r B1}^{′} - {ω}_{r B0}^{′}}$$
where I_{dmin} is determined in response to a largest negative current that does not demagnetize said permanent magnets, K_{d} is a calibration constant, ω′_{rB0} is an adjusted base speed, and ω′_{rB1} is an adjusted calibration speed.

3. A motor controller for a permanent magnet synchronous machine, comprising:
a speed sensor for determining an angular velocity ωᵣ of said machine;
a torque controller for providing a torque command Tₑ*;
a d-axis current calculator for determining a d-axis current command I_{dse}* in response to said torque command;
a q-axis current calculator for determining a q-axis current command I_{qse}* in response to said torque command;
a current regulator for determining a d-axis voltage command V_{dse}* and a q-axis voltage command V_{qse}* corresponding to said d-axis current command I_{dse}* and said q-axis current command I_{qse}*, respectively;
a vector translator for translating said d-axis voltage command V_{dse}* and said q-axis voltage command V_{qse}* into stationary reference commands Vₐ*, V_{b}*, and V_{c}*;
a PWM controller for generating pulse-width modulation control signals corresponding to said stationary reference commands Vₐ*, V_{b}*, and V_{c}*; and
an inverter for applying respective voltages to phase windings of said machine in response to said pulse-width modulation control signals;
wherein said d-axis current calculator comprises:
a maximum torque per ampere scheduler for determining a nominal flux current command;
a speed comparator for determining whether said angular velocity ωᵣ is above a threshold related to a base speed of said machine;
an adjustment calculator for determining an adjusted flux current command including a field-weakening factor which is proportional to said angular velocity ωᵣ; and
a selector for selecting said nominal flux current command when said speed comparator indicates that said angular velocity ωᵣ is below said threshold and for selecting said adjusted flux current command when said speed comparator indicates that said angular velocity ωᵣ is above said threshold.

4. The motor controller of claim 3 wherein said field-weakening factor is substantially defined by
$$( {I}_{d min} \times {K}_{d} - {I}_{dse0}^{*} ) \times \frac{{ω}_{r} - {ω}_{r B0}^{′}}{{ω}_{r B1}^{′} - {ω}_{r B0}^{′}}$$
where I_{dmin} is determined in response to a largest negative current that does not demagnetize said permanent magnets, K_{d} is a calibration constant, ω′_{rB0} is an adjusted base speed, and ω′_{rB1} is an adjusted calibration speed.

5. The motor controller of claim 4 wherein said adjusted flux current command is substantially determined in response to the formula:
$${I}_{dse}^{*} = {I}_{dse0}^{*} + ( {I}_{d min} \times {K}_{d} - {I}_{dse0}^{*} ) \times \frac{{ω}_{r} - {ω}_{r B0}^{′}}{{ω}_{r B1}^{′} - {ω}_{r B0}^{′}}$$
where I*_{dse0} is said maximum torque per ampere value.
